(19) United States
(12) Patent Application Publication
(10) Pub. No.: US 2026/0350444 A1
(43) Pub. Date: Nov. 5, 2026

(54) GEOMETRIC PHASE GATE USING A STATIC MAGNETIC FIELD GRADIENT

(71) Applicant: Quantinuum LLC, Broomfield, CO (US)

(72) Inventors: Robert Tyler SUTHERLAND, San Antonio, TX (US); Michael FEIG, Denver, CO (US)

(21) Appl. No.: 18/441,077

(22) Filed: Feb. 14, 2024

Related U.S. Application Data
(60) Provisional application No. 63/487,076, filed on Feb. 27, 2023.

(51) Int. Cl. G06N 10/20

(52) U.S. Cl. CPC G06N 10/20

(57) ABSTRACT

A controller of a quantum system causes a geometric phase gate to be performed on two or more qubits by causing a first adiabatic coupling of at least one memory state of two or more quantum objects embodying the two or more qubits to a respective magnetic field sensitive state of the two or more quantum objects while the two or more quantum objects are disposed within a static magnetic field gradient zone of a confinement apparatus. The first adiabatic coupling is performed for a shelving time. Responsive to determining that a gate time period has elapsed since a completion of the shelving time, the controller causes a second adiabatic coupling of the at least one memory state to the respective magnetic field sensitive state while the two or more quantum objects are disposed within the static magnetic field gradient zone.

### CROSS-REFERENCE TO RELATED APPLICATIONS

This application claims priority to U.S. Application No. 63/487,076, filed Feb. 27, 2023, the content of which is incorporated herein by reference in its entirety.

### TECHNICAL FIELD

Various embodiments relate to a quantum logic gate using a static magnetic field gradient. Various embodiments relate to a quantum logic gate that does not use any oscillating fields to enact entanglement between quantum objects.

### BACKGROUND

Quantum computing uses quantum interactions to perform quantum computations. An example quantum interaction is the performance of a quantum logic gate on a pair of qubits. For example, a quantum logic gate may be used to entangle two qubits. Conventionally, performance of quantum logic gates includes the application of laser beams or microwaves on the two qubits being gated together in order to cause or mediate the entanglement of the qubits. However, the use of laser beams can lead to photon scattering and/or introduce phase noise during the performance of conventional quantum logic gates, leading to reduced gate fidelity. Two qubit gates caused and/or mediated by microwaves are sensitive to motional errors, require the qubit to be cooled to the motional ground state, and come with resistive heating that could limit their use in future architectures. Through applied effort, ingenuity, and innovation many deficiencies of such conventional quantum logic gates have been solved by developing solutions that are structured in accordance with the embodiments of the present invention, many examples of which are described in detail herein.

### BRIEF SUMMARY OF EXAMPLE EMBODIMENTS

Example embodiments provide methods for enacting a quantum logic gate that uses a static magnetic field gradient to entangle two or more qubits, systems configured for performing such quantum logic gates, controllers configured to cause systems to perform such quantum logic gates, and/or the like. In various embodiments, the quantum logic gate does not use any oscillating fields (e.g., laser beam, microwave signal, oscillating magnetic field) to cause the entanglement of the two or more qubits. Rather the entanglement of two or more qubits is enacted, mediated, and/or caused by a static magnetic field gradient.

In various embodiments, performing the quantum logic gate comprises causing two or more qubits to experience a static magnetic field gradient. For example, two or more quantum objects may be transported into a static magnetic field gradient zone of a confinement apparatus. In various embodiments, the two or more quantum objects are in respective magnetic field insensitive states (e.g., clock states) while being transported. While the two or more quantum objects are disposed within the static magnetic field gradient zone, at least one magnetic field insensitive state of a memory subspace of the quantum objects is adiabatically coupled to a respective magnetic field sensitive state that is outside of the qubit subspace of the quantum objects. For example, the adiabatic coupling may be an adiabatic Rabi flip transition, a rapid adiabatic passage (RAP) (also referred to as an adiabatic rapid passage (ARP)), and/or the like, in various embodiments. After the adiabatic coupling has been performed for a shelving time, the two or more quantum objects experience the static magnetic field gradient of the static magnetic field gradient zone for a gate time period. After the gate time period has elapsed, the respective magnetic field sensitive state is adiabatically coupled to the at least one magnetic field insensitive state of a memory subspace of the quantum objects for a deshelving time. The two or more quantum objects may then be transported out of the static magnetic field gradient zone. The first adiabatic coupling of the at least one magnetic field insensitive state of a memory subspace of the quantum objects to the respective magnetic field sensitive state causes the two or more quantum objects to experience the static magnetic field gradient. The second adiabatic coupling of the respective magnetic field sensitive state to the at least one magnetic field insensitive state of a memory subspace of the quantum objects causes the two or more quantum objects to substantially no longer experience the static magnetic field gradient.

For example, in an example embodiment, performing the quantum logic gate comprises controlling the operation of a confinement apparatus (a) confining at least two quantum objects and (b) defining at least one static magnetic field gradient zone to cause a first adiabatic coupling of at least one qubit state of two or more quantum objects of the at least two quantum objects to a respective magnetic field sensitive state of two or more quantum objects while the two or more quantum objects are disposed within the at least one static magnetic field gradient zone. The first adiabatic coupling is performed for a shelving time. Performing the quantum logic gate further comprises controlling the operation of a confinement apparatus to, responsive to determining that a gate time period has elapsed since a completion of the shelving time, cause a second adiabatic coupling of the at least one qubit state to the respective magnetic field sensitive state while the two or more quantum objects are disposed within the at least one static magnetic field gradient zone.

According to one aspect, a method for performing a geometric phase gate is provided. The method is performed by a controller configured to control operation of one or more components of a quantum system comprising a confinement apparatus (a) configured to confine at least two quantum objects and (b) defining at least one static magnetic field gradient zone. In an example embodiment, the method comprises causing a first adiabatic coupling of at least one memory state of two or more quantum objects of the at least two quantum objects to a respective magnetic field sensitive state of two or more quantum objects while the two or more quantum objects are disposed within the at least one static magnetic field gradient zone. The first adiabatic coupling is performed for a shelving time. The method further comprises, responsive to determining that a gate time period has elapsed since a completion of the shelving time, causing a second adiabatic coupling of the at least one memory state to the respective magnetic field sensitive state while the two or more quantum objects are disposed within the at least one static magnetic field gradient zone.

In an example embodiment, the two or more quantum objects are entangled within the static magnetic field gradient zone during the gate time period without use of any oscillating fields to enact/mediate entanglement of the two or more quantum objects.

In an example embodiment, the static magnetic field gradient enacts/mediates entanglement of the two or more quantum objects within the static magnetic field gradient zone.

In an example embodiment, the gate time period is determined based at least in part on an amount of time it takes for the static magnetic field gradient to mediate/enact/cause the entanglement of the two or more quantum objects.

In an example embodiment, causing the first adiabatic coupling comprises causing a manipulation signal that (a) at an initial time is characterized by (i) a detuning from a transition between the at least one memory state and the respective magnetic field sensitive state that is equal to an initial detuning and (ii) an initial amplitude, (b) at a finale time is characterized by (i) the detuning from the transition that is equal to a final detuning that is of substantially equal magnitude and opposite sign of the initial detuning and (ii) a final amplitude substantially equal to the initial amplitude, and (c) between the initial time and the final time, (i) the detuning smoothly and monotonically transitions from the initial detuning to the final detuning and (ii) the amplitude increases from the initial amplitude to a maximum amplitude and then decreases from the maximum amplitude to the final amplitude, the amplitude being equal to the maximum amplitude when the detuning from the transition is equal to zero.

In an example embodiment, the first adiabatic coupling is a rapid adiabatic passage, and the second adiabatic coupling is a reverse of the first adiabatic coupling.

In an example embodiment, the second adiabatic coupling is performed for a deshelving time.

In an example embodiment, the shelving time and the deshelving time are respectively in a range of 5-10 microseconds (μs).

In an example embodiment, at least one of the first adiabatic coupling or the second adiabatic coupling is a Rabi flop transition.

In an example embodiment, the method further comprises, prior to causing the first adiabatic coupling, causing the two or more quantum objects to be transported into the at least one static magnetic field gradient zone.

In an example embodiment, a first potential generating signal filtering scheme is used to filter potential generating signals used to cause the two or more quantum objects to be transported into the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, the method further comprises, after causing the second adiabatic coupling to be performed for a deshelving time, causing the two or more quantum objects to be transported out of the at least one static magnetic field gradient zone.

In an example embodiment, a first potential generating signal filtering scheme is used to filter potential generating signals used to cause the two or more quantum objects to be transported out of the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, causing at least one of the first adiabatic coupling or the second adiabatic coupling comprises controlling operation of a manipulation source of the quantum system to cause at least one manipulation signal to be incident on the two or more quantum objects disposed within the static magnetic field gradient zone.

In an example embodiment, the at least one manipulation signal comprises at least one of a microwave signal or a laser beam.

According to another aspect, a system configured to perform a geometric phase gate is provided. In an example embodiment, the system comprises a confinement apparatus defining (at least in part) at least one static magnetic field gradient zone and operable to confine two or more quantum objects. The system further comprises a controller configured to control operation of the confinement apparatus. The controller is configured to control operation of one or more components of the system to perform causing a first adiabatic coupling of at least one memory state of two or more quantum objects of the at least two quantum objects to a respective magnetic field sensitive state of two or more quantum objects while the two or more quantum objects are disposed within the at least one static magnetic field gradient zone. The first adiabatic coupling is performed for a shelving time. The controller is further configured to control operation of one or more components of the system to perform, responsive to determining that a gate time period has elapsed since a completion of the shelving time, causing a second adiabatic coupling of the at least one memory state to the respective magnetic field sensitive state while the two or more quantum objects are disposed within the at least one static magnetic field gradient zone.

In an example embodiment, the two or more quantum objects are entangled within the static magnetic field gradient zone during the gate time period without use of any oscillating fields to enact/mediate entanglement of the two or more quantum objects.

In an example embodiment, the static magnetic field gradient enacts/mediates entanglement of the two or more quantum objects within the static magnetic field gradient zone.

In an example embodiment, the gate time period is determined based at least in part on an amount of time it takes for the static magnetic field gradient to mediate/enact/cause the entanglement of the two or more quantum objects.

In an example embodiment, causing the first adiabatic coupling comprises causing a manipulation signal that (a) at an initial time is characterized by (i) a detuning from a transition between the at least one memory state and the respective magnetic field sensitive state that is equal to an initial detuning and (ii) an initial amplitude, (b) at a finale time is characterized by (i) the detuning from the transition that is equal to a final detuning that is of substantially equal magnitude and opposite sign of the initial detuning and (ii) a final amplitude substantially equal to the initial amplitude, and (c) between the initial time and the final time, (i) the detuning smoothly and monotonically transitions from the initial detuning to the final detuning and (ii) the amplitude increases from the initial amplitude to a maximum amplitude and then decreases from the maximum amplitude to the final amplitude, the amplitude being equal to the maximum amplitude when the detuning from the transition is equal to zero.

In an example embodiment, the first adiabatic coupling is a rapid adiabatic passage, and the second adiabatic coupling is a reverse of the first adiabatic coupling.

In an example embodiment, the second adiabatic coupling is performed for a deshelving time.

In an example embodiment, the shelving time and the deshelving time are respectively in a range of 5-10 μs.

In an example embodiment, at least one of the first adiabatic coupling or the second adiabatic coupling is a Rabi flop transition.

In an example embodiment, the controller is further configured to control operation of one or more components of the system to perform, prior to causing the first adiabatic coupling, causing the two or more quantum objects to be transported into the at least one static magnetic field gradient zone.

In an example embodiment, a first potential generating signal filtering scheme is used to filter potential generating signals used to cause the two or more quantum objects to be transported into the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, the method further comprises, after causing the second adiabatic coupling to be performed for a deshelving time, causing the two or more quantum objects to be transported out of the at least one static magnetic field gradient zone.

In an example embodiment, a first potential generating signal filtering scheme is used to filter potential generating signals used to cause the two or more quantum objects to be transported out of the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, causing at least one of the first adiabatic coupling or the second adiabatic coupling comprises controlling operation of a manipulation source of the quantum system to cause at least one manipulation signal to be incident on the two or more quantum objects disposed within the static magnetic field gradient zone.

In an example embodiment, the at least one manipulation signal comprises at least one of a microwave signal or a laser beam.

According to another aspect, a controller configured to control one or more components of a quantum system and configured to cause the quantum system to perform a geometric phase gate is provided. In an example embodiment, the controller comprises a processing device, memory storing executable instructions, and driver controller elements. The executable instructions are configured to, when executed by the processing device, cause the controller to use the driver controller elements to control operation of a confinement apparatus to perform causing a first adiabatic coupling of at least one memory state of two or more quantum objects of the at least two quantum objects to a respective magnetic field sensitive state of two or more quantum objects while the two or more quantum objects are disposed within the at least one static magnetic field gradient zone. The first adiabatic coupling is performed for a shelving time. The executable instructions are further configured to, when executed by the processing device, cause the controller to use the driver controller elements to control operation of a confinement apparatus to perform, responsive to determining that a gate time period has elapsed since a completion of the shelving time, causing a second adiabatic coupling of the at least one memory state to the respective magnetic field sensitive state while the two or more quantum objects are disposed within the at least one static magnetic field gradient zone.

In an example embodiment, the two or more quantum objects are entangled within the static magnetic field gradient zone during the gate time period without use of any oscillating fields to enact/mediate entanglement of the two or more quantum objects.

In an example embodiment, the static magnetic field gradient enacts/mediates entanglement of the two or more quantum objects within the static magnetic field gradient zone.

In an example embodiment, the gate time period is determined based at least in part on an amount of time it takes for the static magnetic field gradient to mediate/enact/cause the entanglement of the two or more quantum objects.

In an example embodiment, causing the first adiabatic coupling comprises causing a manipulation signal that (a) at an initial time is characterized by (i) a detuning from a transition between the at least one memory state and the respective magnetic field sensitive state that is equal to an initial detuning and (ii) an initial amplitude, (b) at a finale time is characterized by (i) the detuning from the transition that is equal to a final detuning that is of substantially equal magnitude and opposite sign of the initial detuning and (ii) a final amplitude substantially equal to the initial amplitude, and (c) between the initial time and the final time, (i) the detuning smoothly and monotonically transitions from the initial detuning to the final detuning and (ii) the amplitude increases from the initial amplitude to a maximum amplitude and then decreases from the maximum amplitude to the final amplitude, the amplitude being equal to the maximum amplitude when the detuning from the transition is equal to zero.

In an example embodiment, the first adiabatic coupling is a rapid adiabatic passage, and the second adiabatic coupling is a reverse of the first adiabatic coupling.

In an example embodiment, the second adiabatic coupling is performed for a deshelving time.

In an example embodiment, the shelving time and the deshelving time are respectively in a range of 5-10 μs.

In an example embodiment, at least one of the first adiabatic coupling or the second adiabatic coupling is a Rabi flop transition.

In an example embodiment, the executable instructions are further configured to, when executed by the processing device, cause the controller to use the driver controller elements to control operation of a confinement apparatus to perform, prior to causing the first adiabatic coupling, causing the two or more quantum objects to be transported into the at least one static magnetic field gradient zone.

In an example embodiment, a first potential generating signal filtering scheme is used to filter potential generating signals used to cause the two or more quantum objects to be transported into the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, the method further comprises, after causing the second adiabatic coupling to be performed for a deshelving time, causing the two or more quantum objects to be transported out of the at least one static magnetic field gradient zone.

In an example embodiment, a first potential generating signal filtering scheme is used to filter potential generating signals used to cause the two or more quantum objects to be transported out of the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, causing at least one of the first adiabatic coupling or the second adiabatic coupling comprises controlling operation of a manipulation source of the quantum system to cause at least one manipulation signal to be incident on the two or more quantum objects disposed within the static magnetic field gradient zone.

In an example embodiment, the at least one manipulation signal comprises at least one of a microwave signal or a laser beam.

According to still another aspect, a computer program product is provided. In an example embodiment, the computer program product comprises at least one non-transitory computer-readable medium storing executable instructions. The executable instructions are configured to, when executed by a processing device of a controller configured to control one or more components of a quantum system comprising a confinement apparatus (a) configured to confine at least two quantum objects and (b) defining at least one static magnetic field gradient zone, cause the controller to perform causing a first adiabatic coupling of at least one memory state of two or more quantum objects of the at least two quantum objects to a respective magnetic field sensitive state of two or more quantum objects while the two or more quantum objects are disposed within the at least one static magnetic field gradient zone. The first adiabatic coupling is performed for a shelving time. The executable instructions are further configured to, when executed by the processing device of the controller, cause the controller to perform responsive to determining that a gate time period has elapsed since a completion of the shelving time, causing a second adiabatic coupling of the at least one memory state to the respective magnetic field sensitive state while the two or more quantum objects are disposed within the at least one static magnetic field gradient zone.

In an example embodiment, the two or more quantum objects are entangled within the static magnetic field gradient zone during the gate time period without use of any oscillating fields to enact/mediate entanglement of the two or more quantum objects.

In an example embodiment, the static magnetic field gradient enacts/mediates entanglement of the two or more quantum objects within the static magnetic field gradient zone.

In an example embodiment, the gate time period is determined based at least in part on an amount of time it takes for the static magnetic field gradient to mediate/enact/cause the entanglement of the two or more quantum objects.

In an example embodiment, causing the first adiabatic coupling comprises causing a manipulation signal that (a) at an initial time is characterized by (i) a detuning from a transition between the at least one memory state and the respective magnetic field sensitive state that is equal to an initial detuning and (ii) an initial amplitude, (b) at a finale time is characterized by (i) the detuning from the transition that is equal to a final detuning that is of substantially equal magnitude and opposite sign of the initial detuning and (ii) a final amplitude substantially equal to the initial amplitude, and (c) between the initial time and the final time, (i) the detuning smoothly and monotonically transitions from the initial detuning to the final detuning and (ii) the amplitude increases from the initial amplitude to a maximum amplitude and then decreases from the maximum amplitude to the final amplitude, the amplitude being equal to the maximum amplitude when the detuning from the transition is equal to zero.

In an example embodiment, the first adiabatic coupling is a rapid adiabatic passage, and the second adiabatic coupling is a reverse of the first adiabatic coupling.

In an example embodiment, the second adiabatic coupling is performed for a deshelving time.

In an example embodiment, the shelving time and the deshelving time are respectively in a range of 5-10 μs.

In an example embodiment, at least one of the first adiabatic coupling or the second adiabatic coupling is a Rabi flop transition.

In an example embodiment, the executable instructions are further configured to, when executed by the processing device of the controller, cause the controller to perform, prior to causing the first adiabatic coupling, causing the two or more quantum objects to be transported into the at least one static magnetic field gradient zone.

In an example embodiment, a first potential generating signal filtering scheme is used to filter potential generating signals used to cause the two or more quantum objects to be transported into the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, the method further comprises, after causing the second adiabatic coupling to be performed for a deshelving time, causing the two or more quantum objects to be transported out of the at least one static magnetic field gradient zone.

In an example embodiment, a first potential generating signal filtering scheme is used to filter potential generating signals used to cause the two or more quantum objects to be transported out of the at least one static magnetic field gradient zone.

In an example embodiment, a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

In an example embodiment, causing at least one of the first adiabatic coupling or the second adiabatic coupling comprises controlling operation of a manipulation source of the quantum system to cause at least one manipulation signal to be incident on the two or more quantum objects disposed within the static magnetic field gradient zone.

In an example embodiment, the at least one manipulation signal comprises at least one of a microwave signal or a laser beam.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a block diagram of an example quantum charge-coupled device (QCCD)-based quantum system, in accordance with an example embodiment.

FIG. 2 provides a schematic diagram of a top view of an example confinement region of a confinement apparatus that includes a static magnetic field gradient zone, in accordance with an example embodiment.

FIG. 3 provides a schematic diagram of a top view of at least a portion of a confinement apparatus, in accordance with an example embodiment.

FIG. 4 provides flowchart illustrating processes, procedures, and/or operations for performing a geometric phase gate, in accordance with an example embodiment.

FIG. 5A provides a plot illustrating the evolution of the amplitude and detuning of a manipulation signal used to perform a first adiabatic coupling, in accordance with various embodiments.

FIG. 5B provides a plot illustrating the evolution of the amplitude and detuning of a manipulation signal used to perform a second adiabatic coupling, in accordance with various embodiments.

FIG. 5C provides a timeline for performing a geometric phase gate, in accordance with various embodiments.

FIG. 6 provides an example partial quantum state diagram illustrating a memory subspace and a gate subspace, in accordance with an example embodiment.

FIG. 7 provides a schematic diagram of an example controller of a quantum system, in accordance with an example embodiment.

FIG. 8 provides a schematic diagram of an example computing entity of a quantum system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within appropriate engineering and/or manufacturing limits and/or within user measurement capabilities, unless otherwise indicated. Like numbers refer to like elements throughout.

Various embodiments, provide methods, quantum systems, controllers, computer program products, and/or the like for performing a quantum logic gate. As used herein, a quantum logic gate is performed on two or more quantum objects by gating the two or more quantum objects with one another and/or causing an interaction between/among the two or more quantum objects such that the logic function of the quantum logic gate is enacted through the interaction of the two or more quantum objects. In various embodiment, the quantum logic gate is a geometric phase gate that includes the entanglement of two or more qubits. The entanglement of the two or more qubits is enacted, mediated, and/or caused to occur by a static magnetic field gradient. In particular, the entanglement of the two or more qubits does not require any oscillating fields (e.g., laser beams, microwaves, oscillating magnetic fields, and/or the like). For example, no oscillating fields are used to enact, mediate, and/or cause the entanglement of the two or more qubits, in various embodiments of the quantum logic gate.

In various embodiments, performing the quantum logic gate comprises causing two or more qubits to experience a static magnetic field gradient. After and/or responsive to determining that a gate time period has elapsed since the two or more qubits started experiencing the static magnetic field gradient, the two or more qubits are caused to no longer experience the static magnetic field gradient. In an example embodiment, the gate time period is determined at least in part based on an amount of time it takes for the static magnetic field gradient to enact, mediate, and/or cause an entanglement of the quantum states of the two or more quantum objects.

In various embodiments, the two or more qubits (e.g., embodied as respective quantum objects) are caused to experience the static magnetic field gradient through the performance of a first adiabatic coupling at least one magnetic field insensitive memory subspace state to a respective magnetic field sensitive gate subspace state while the two or more qubits are disposed within a static magnetic field gradient zone of a confinement apparatus. In various embodiments, the two or more qubits (e.g., embodied as respective quantum objects) are caused to no longer experience the static magnetic field gradient through the performance of a second adiabatic coupling of the at least one magnetic field insensitive memory subspace state to a respective magnetic field sensitive gate subspace state while the two or more qubits are disposed within a static magnetic field gradient zone of a confinement apparatus. For example, the first and/or second adiabatic coupling may be performed as an adiabatic Rabi flop transition or as a rapid adiabatic passage (RAP).

Performance of conventional quantum logic gates require oscillating fields such as laser beams, microwaves, oscillating magnetic fields, and/or the like to enact, mediate, and/or cause the entanglement of qubits. However, these oscillating fields may lead to various gate errors such as photon scattering and/or affecting transitions in spectator qubits, which can lead to crosstalk problems, phase noise, and/or the like. These gate errors can lead to low fidelity logic gates and noisy computations. Moreover, quantum logic gates that use oscillating fields are highly sensitive to the state of one or more motional modes of the qubits. Therefore, spin-motion coupling can lead to additional gate errors and/or a significant amount of time is needed to cool the qubits to close to their motional ground states prior to performance of a quantum logic gate. Thus, various technical problems exist regarding the performance of quantum logic gates.

Various embodiments provide technical solutions to these technical problems. In various embodiments, a quantum logic gate is performed by using a static magnetic field gradient to enact, mediate, and/or cause entanglement of two or more qubits. Since the static magnetic field gradient is a static field (e.g., substantially not changing with time at least during the performance of the quantum logic gate), the quantum logic gate disclosed herein is immune to phase noise and the primary mechanisms leading to cross talk-related errors. Additionally, the quantum logic gate of various embodiments is insensitive to the motional mode and/or temperature of the qubits. Thus, time intensive cooling operations can be avoided and/or reduced. As such, various embodiments provide an improved quantum logic gate, methods for performing an improved quantum logic gate, quantum systems configured for performing an improved quantum logic gate, controller configured to cause quantum systems to perform an improved quantum logic gate, and/or the like.

Moreover, in order to perform a static magnetic field gradient-mediated and/or enacted quantum logic gate that is insensitive to motional errors, the qubits on which the quantum logic gate is being enacted should experience the static magnetic field gradient turning on and/or ramping up slowly compared to the motional frequency of the qubits, which is dictated by the trap confinement. This slow turn on and/or ramp up of the qubit experiencing the static magnetic field gradient is performed, in various embodiments, by transporting the qubits to be gated together into a static magnetic field gradient zone defined by the confinement apparatus where the static magnetic field gradient is present. The qubits are transported while in respective “clock” states (e.g., magnetic field insensitive states with quantum number m=0) of the memory subspace of the quantum objects embodying the qubits.

Various embodiments of an example quantum logic gate will now be described with respect to an example QCCD-based quantum system.

### Example QCCD-Based Quantum System

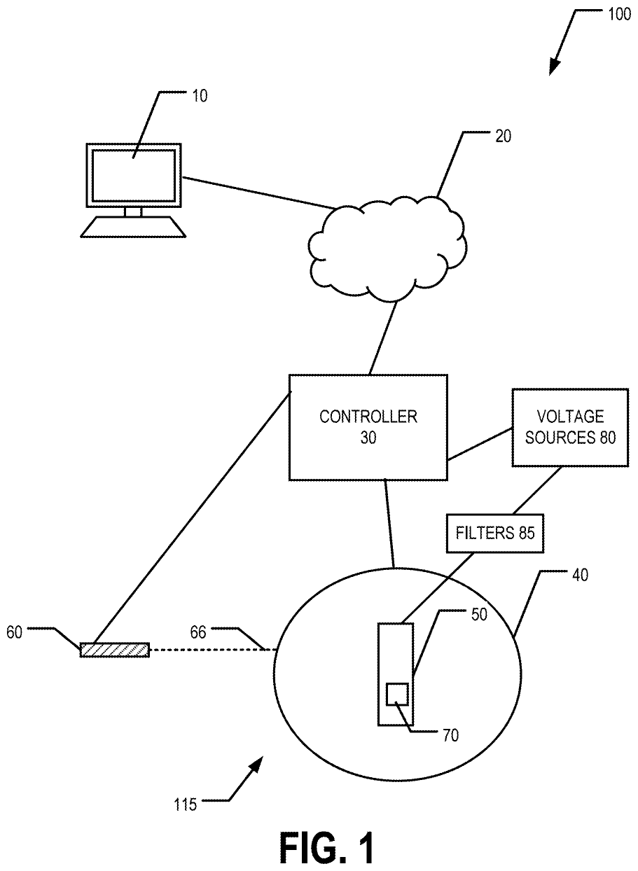

FIG. 1 provides a schematic diagram of an example QCCD-based quantum system 100 that can be used to perform a quantum logic gate of various embodiments. The example QCCD-based quantum system 100 shown in FIG. 1 is a quantum computer system comprising a quantum object confinement apparatus 50 (e.g., an ion trap) defining, at least in part, at least one static magnetic field gradient zone. For example, the confinement apparatus 50 comprises or is physically associated a static magnetic field gradient source 70.

In various embodiments, the static magnetic field gradient source 70 is a permanent magnet (e.g., a ferromagnet) and/or an array of permanent magnets that is part of the confinement apparatus 50 (e.g., disposed and/or embedded in the same substrate and/or chip as the confinement apparatus 50) or disposed in physical proximity to the confinement apparatus 50 such that quantum objects confined within a static magnetic field gradient zone of the confinement apparatus experience a static magnetic field gradient. In an example embodiment, the static magnetic field gradient source 70 is an electromagnet, an array of electromagnets, and/or an array of magnets comprising at least one electromagnet and at least one permanent magnet that is part of the confinement apparatus 50 (e.g., disposed and/or embedded in the same substrate and/or chip as the confinement apparatus 50) or disposed in physical proximity to the confinement apparatus 50 such that quantum objects confined within a static magnetic field gradient zone of the confinement apparatus (and in a magnetic field sensitive state such as a gate subspace state) experience a static magnetic field gradient.

In various embodiments, the confinement apparatus 50 is configured to confine quantum objects in one or more confinement regions defined by the confinement apparatus 50. In various embodiments, a quantum object is a neutral or charged atom; a neutral, charged, or multipole molecule; quantum particle; quantum dot; or other object that is able to be confined by the confinement apparatus and having a quantum state that is manipulatable via one or more manipulation signals and/or interactions with static electric and/or magnetic fields. In various embodiments, the quantum objects embody the qubits of the QCCD-based quantum system 100. In an example embodiment, the confinement apparatus 50 is an ion trap and the quantum objects are ions.

In various embodiments, the QCCD-based quantum system 100 comprises a computing entity 10 and a quantum computer 110. In various embodiments, the quantum computer 110 comprises a controller 30 and a quantum processor 115. In various embodiments, the quantum processor 115 comprises a cryogenic and/or vacuum chamber 40 enclosing a confinement apparatus 50 and static magnetic field gradient source 70, and one or more manipulation sources 60. In an example embodiment, the one or more manipulation sources 60 comprise one or more optical sources such as lasers, microwave sources, and/or the like.

In various embodiments, the one or more manipulation sources 60 are configured to generate and/or provide manipulation signals (e.g., optical beams) configured to manipulate and/or cause a controlled quantum state evolution of one or more quantum objects confined by the confinement apparatus 50. For example, in an example embodiment, wherein the one or more manipulation sources 60 comprise one or more lasers, the lasers may provide one or more optical beams and/or laser beams (e.g., pi pulses, for example) to the confinement apparatus 50 within the cryogenic and/or vacuum chamber 40 via respective beam/signal delivery systems 66. In various embodiments, a beam/signal delivery system 66 comprises one or more optical elements, photonic integrated circuits (PICs), optical fibers, free space optical elements, waveguides, and/or the like.

In various embodiments, the quantum processor 115 further comprises a plurality of voltage sources 80. The voltage sources 80 are operable (e.g., by the controller 30) to generate and provide potential generating signals to electrical elements (e.g., electrodes) of the confinement apparatus 50, any electromagnets of the static magnetic field gradient source 70, and/or the like. In various embodiments, the potential generating signals are filtered and/or conditioned using filters 85 prior to the potential generating signals being applied to the control electrodes of the confinement apparatus.

In various embodiments, the filters 85 are capable of being operated in accordance with at least two different filtering schemes. For example, in various embodiments, the filters 85 may be operated in accordance with a selected one of a first potential generating signal filtering scheme or a second potential generating signal filtering scheme. For example, the first potential generating signal filtering scheme is configured to enable and/or facilitate efficient and/or rapid transportation of quantum objects and the second potential generating signal filtering scheme is configured to enable and/or facilitate the generation of a low noise potential well for confining quantum objects at respective locations of the confinement apparatus. For example, in an example embodiment, when the filters 85 are operated in accordance with the first potential generating signal filtering scheme, the filters 85 are operated to enact a low pass filter (or a high pass filter or band pass filter) with a first cut off frequency and, when the filters 85 are operated in accordance with the second potential generating signal filtering scheme, the filters 85 are operated to enact a low pass filter (or a high pass filter or band pass filter) with a second cut off frequency, where the first cut off frequency and the second cut off frequency are different. For example, the first potential generating signal filtering scheme and the second potential generating filtering scheme may cause respective filtered potential generating signals to have different spectra, different frequency profiles, different noise profiles, and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand and/or implement.

In various embodiments, the controller 30 is configured to control the voltage sources 80, filters 85, cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects (e.g., ions) confined by the confinement apparatus 50 (e.g., ion trap). In various embodiments, the quantum objects confined by the confinement apparatus 50 are used as qubits of the quantum computer 110.

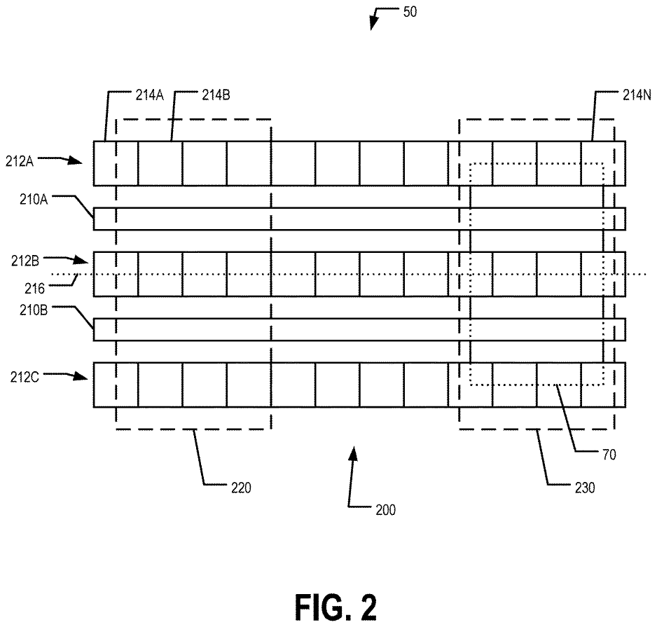

FIG. 2 illustrates a top view of a portion of a confinement apparatus 50. The illustrated portion of the confinement apparatus 50 includes radio frequency (RF) rails 210A, 210B and three sequences of control electrodes 212A, 212B, 212C. Each sequence of control electrodes 212 comprises a plurality of control electrodes 214. For example, the illustrated portion of the sequence of control electrodes 212A includes control electrodes 214A, 214B, . . . , 214N.

In various embodiments, RF voltage sources of the voltage sources 80 generate and provide a potential generating signal (e.g., an RF voltage signal) that is applied to the RF rails 210A, 210B to generate a pseudopotential that defines one or more linear confinement regions 200 of the confinement apparatus 50. The null point of the pseudopotential generated by the RF voltage signals being applied to the RF rails 210A, 210B defines the RF null axis 216 that extends substantially along a center line of the linear confinement region 200. The quantum objects confined by the confinement apparatus 50 are confined in the one or more linear confinement regions 200.

In various embodiments, the confinement apparatus 50 and the static magnetic field gradient source 70 define a static magnetic field gradient zone 230. When a quantum object is confined by the confinement apparatus 50 within the static magnetic field gradient zone 230, the quantum object experiences a static magnetic field gradient. The static magnetic field gradient is referred to herein as static because the magnetic field gradient is substantially stable (e.g., not changing) with time at least while a quantum logic gate is being performed in the static magnetic field gradient zone.

In various embodiments, the voltage sources 80 generate and provide potential generating signals that are applied to respective control electrodes 214 of the sequences of control electrodes 212. In various embodiments, the potential generating signals are filtered by filters 85 prior to being applied to the respective control electrodes 214. In various embodiments, the filters 85 are configured to be operated in at least two different filtering schemes. For example, the filters 85 may be configured to be operated in accordance with a first potential generating signal filtering scheme when the potential generating signals are configured to cause transportation of one or more quantum objects within the confinement apparatus. For example, the filters 85 may be operated in accordance with a first potential generating signal filtering scheme when the potential generating signals are configured to cause one or more quantum objects to be transported from one or more respective starting locations to one or more respective destination locations. The filters 85 may be further configured to be operated in accordance with a second potential generating signal filtering scheme when the potential generating signals are configured to cause one or more quantum objects to maintain their respective locations within the confinement apparatus.

For example, in an example embodiment, when the filters 85 are operated in accordance with the first potential generating signal filtering scheme, the filters 85 are operated to enact a low pass filter (or a high pass filter or band pass filter) with a first cut off frequency(ies) and, when the filters 85 are operated in accordance with the second potential generating signal filtering scheme, the filters 85 are operated to enact a low pass filter (or a high pass filter or band pass filter) with a second cut off frequency(ies), where the first cut off frequency(ies) and the second cut off frequency(ies) are different. In various embodiments, potential generating signals (e.g., voltage signals) filtered in accordance with the first potential generating signal filtering scheme have a different noise profile, different frequency profile, different spectra, and/or the like compared to a potential generating signal generated by filtering the same source potential generating signal in accordance with the second potential generating signal filtering scheme.

In various embodiments, the confinement apparatus 50 and one or more beam/signal delivery systems 66 define an oscillating field zone 220. In various embodiments, the oscillating field zone 220 is configured such that when a quantum object is disposed within the oscillating field zone 220, a manipulation signal may be incident on the quantum object. For example, the beam/signal delivery system 66 is configured such that a manipulation signal generated by a manipulation source 60 is applied to the confinement apparatus 50 within the oscillating field zone 220 such that the manipulation signal may be incident on a quantum object disposed within the oscillating field zone 220.

The quantum objects confined by the confinement apparatus 50 may be transported between different locations of the confinement apparatus 120 through the application of sets of potential generating signal sequences to the control electrodes 212. For example, a quantum object (or multiple quantum objects) may be transported back and forth between the oscillating field zone 220 and the static magnetic field gradient zone 230 and/or other locations defined by the confinement apparatus 50. For example, the controller 30 is configured to control the voltage sources 80 to cause performance of a transport operation on a quantum object (or group of quantum objects) between various locations defined by the confinement apparatus 50. In various embodiments, the potential generating signals applied to control electrodes 214 that are being used to perform a transportation operation are filtered (by the filters 85) in accordance with a first potential generating signal filtering scheme and potential generating signals applied to control electrodes 214 that are not being used to perform a transportation operation (e.g., that are being used to maintain a quantum object at a respective location) are filtered (by the filters 85) in accordance with a second potential generating signal filtering scheme.

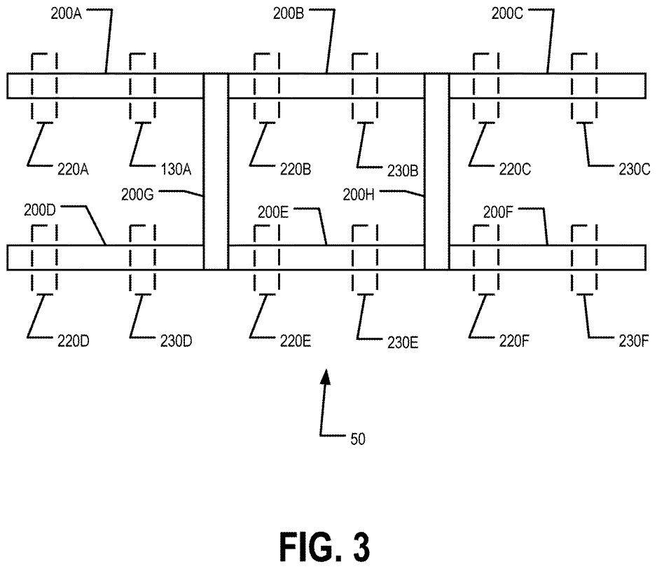

In an example embodiment, the confinement apparatus 50 comprises and/or defines a single linear confinement region 200. In various embodiments, the confinement apparatus 50 comprises and/or defines a plurality and/or an array of confinement regions 200. FIG. 3 provides a top view of a portion of a confinement apparatus 50 illustrating a two-dimensional array of confinement regions 200 (e.g., 200A, 200B, 200C, 200D, 200E, 200F, 200G, 200H). In the illustrated embodiment, a plurality of oscillating field zones 220 (e.g., 220A, 220B, 220C, 220D, 220E, 220F) and/or a plurality of static magnetic field gradient zones 230 (e.g., 230A, 230B, 230C, 230D, 230E, 230F) are defined along the array of confinement regions. For example, the plurality of a plurality of oscillating field zones 220 (e.g., 220A, 220B, 220C, 220D, 220E, 220F) and/or a plurality of static magnetic field gradient zones 230 (e.g., 230A, 230B, 230C, 230D, 230E, 230F) provide a periodic array of oscillating field zones 220 and/or static magnetic field gradient zones, respectively, in the illustrated embodiment.

### Example Operation of a Quantum System to Perform a Quantum Logic Gate

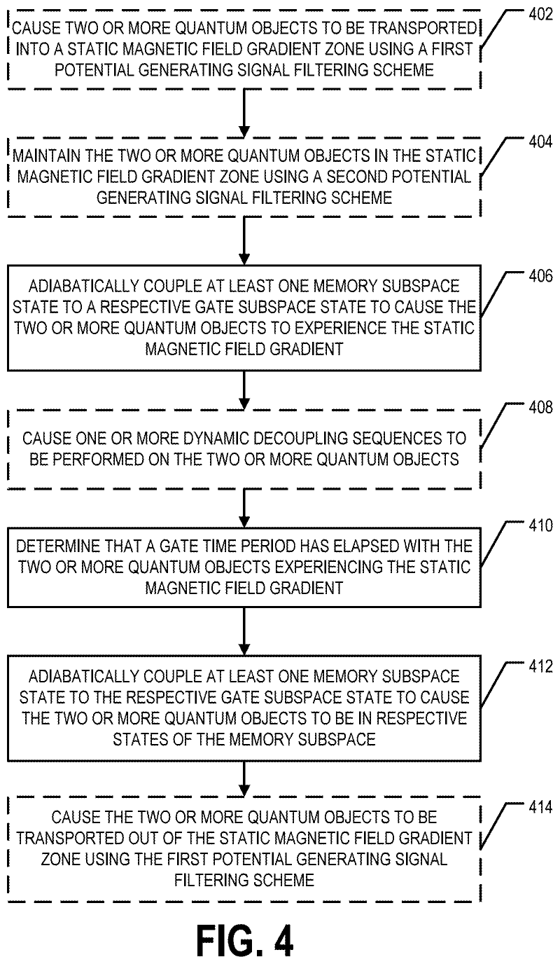

In various systems, a quantum system, such as the QCCD-based quantum system 100 is operable to perform a quantum logic gate such that a static magnetic field gradient is used to enact, mediate, and/or cause the entanglement of two or more qubits corresponding to quantum logic gate. FIG. 4 provides a flowchart illustrating various processes, procedures, operations, and/or the like that may be performed (e.g., by a controller 30) to cause a quantum logic gate to be performed in accordance with various embodiments.

In various embodiments, the quantum logic gate performed through the processes, procedures, operations, and/or the like of FIG. 4 causes the entanglement of two or more qubits with the entanglement enacted, mediated, and/or caused by a static magnetic field gradient. In various embodiments, no oscillating fields are used to enact, mediate, and/or cause the entanglement of the two or more qubits when the quantum logic gate is performed.

In various embodiments, qubits (e.g., quantum bits) are embodied as quantum objects. For example, the quantum state of a quantum object is used to encode information that is the result of a quantum computation. For example, the controlled evolution of the respective quantum states of a plurality of quantum objects results in the performance of a quantum computation. The terms quantum object and qubit are used interchangeably herein.

Responsive to determining that two or more quantum objects are to be interacted with one another via a quantum logic gate, the controller 30 may transport the two or more quantum objects to a common location. In an example embodiment, the common location is within a static magnetic field gradient zone 230.

For example, at step 402, the controller 30 causes the two or more quantum objects upon which the quantum logic gate is to be performed to be transported into the static magnetic field gradient zone 230. For example, the controller 30 may control operation of the voltage sources 80, filters 85, and/or confinement apparatus 50 such that the potential well(s) in which the two or more quantum objects are disposed to be transported into a static magnetic field gradient zone 230. In various embodiments, the two or more quantum objects are in respective magnetic field insensitive states (e.g., “clock” states or m=0 states) of the memory subspace while the two or more quantum objects are transported into the static magnetic field gradient zone 230. In an example embodiment, the potential generating signals that are applied to the control electrodes of the confinement apparatus 50 that are configured to cause the transportation of the two or more quantum objects into the static magnetic field gradient zone 230 are filtered by filters 85 in accordance with a first potential generating signal filtering scheme.

At step 404, the controller 30 causes the two or more quantum objects upon which the quantum logic gate is to be maintained within the static magnetic field gradient zone 230. For example, the controller 30 may control operation of the voltage sources 80, filters 85, and/or confinement apparatus 50 such that the potential well(s) in which the two or more quantum objects are disposed to be maintained a static magnetic field gradient zone 230. In an example embodiment, the potential generating signals that are applied to the control electrodes of the confinement apparatus 50 that are configured to cause the transportation of the two or more quantum objects into the static magnetic field gradient zone 230 are filtered by filters 85 in accordance with a second potential generating signal filtering scheme. For example, the second potential generating filtering scheme may be configured to cause the control electrodes to which the filtered potential generating signals are applied to generate a low noise potential well.

At step 406, the controller 30 causes at least one of the memory subspace states to be adiabatically coupled to a respective gate subspace state. For example, the controller 30 may control operation of one or more manipulation sources to cause one or more manipulation signals (microwave signals, laser beams, and/or the like) to be incident on the two or more quantum objects disposed within the static magnetic field gradient zone 230 to cause a first adiabatic coupling. The one or more manipulation signals and/or the first adiabatic coupling cause(s) the at least one of the memory subspace states to be adiabatically coupled to the respective gate subspace state. In various embodiments, adiabatically coupling the at least one memory subspace state to the respective gate subspace state causes quantum objects in the at least one memory subspace state to transition to the respective gate subspace state in an adiabatic manner.

As should be understood by one of skill in the art, an adiabatic coupling or a transition that is adiabatic in manner is a quantum state coupling or transition that occurs slowly enough to prevent the quantum object undergoing the coupling or transition to transition to other eigenstates. For example, the coupling and/or transition occurs slowly relative to the frequency difference of the instantaneous energy eigenstates of the quantum object at all times during the coupling and/or transition.

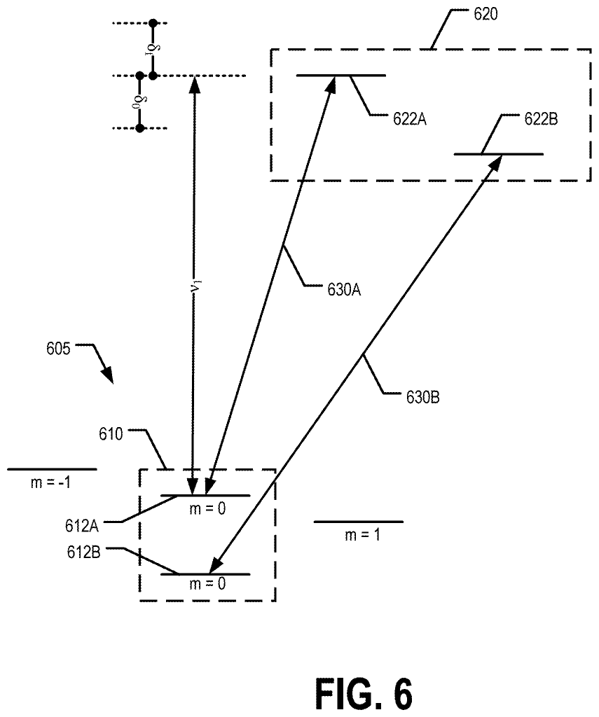

In various embodiments, the states of the memory subspace are the states that read as the qubit bright/dark states or |0>/|1> states. In various embodiments, the states of the memory subspace are insensitive to magnetic fields, have quantum number m=0, and/or are “clock” states. In various embodiments, a gate subspace is defined as a subset of the quantum states of the quantum objects. In various embodiments, the one or more states of a gate subspace are each sensitive to magnetic fields, are Zeeman states, and/or have quantum number m≠0. FIG. 6 illustrates a partial energy diagram illustrating some of the quantum states of a quantum object. A memory subspace 610 is defined in a ground state manifold 605 (e.g., S-manifold) of the quantum object. In the illustrated embodiment, the memory subspace 610 comprises two quantum states—a first memory subspace state 612A and a second memory subspace state 612B. In the illustrated embodiment, the first and second memory subspace states 612A, 612B are clock states (e.g., magnetic quantum number m=0).

In various embodiments, a gate subspace 620 is defined. In particular, the gate subspace 620 is defined to include a first gate subspace state 622A and a second gate subspace state 622B. The first gate subspace state 622A is chosen and/or selected such that the first memory subspace state 612A may be coupled to the first gate subspace state 622A via a first manipulation signal 630A. For example, the first manipulation signal 630A is a pi pulse of a laser beam characterized by a frequency that is resonant or close to resonant with the energy difference between the first memory subspace state 612A and the first gate subspace state 622A, in an example embodiment.

The second gate subspace state 622B is chosen and/or selected such that the second memory subspace state 612B may be coupled to the second gate subspace state 622B via a second manipulation signal 630B. For example, the second manipulation signal 630B is a pi pulse of a laser beam characterized by a frequency that is resonant or close to resonant with the energy difference between the second memory subspace state 612B and the second gate subspace state 622B. In an example embodiment, the first and second manipulation signals are characterized by the same frequency (e.g., the frequency difference between the first memory subspace state 612A and the first gate subspace state 622A and the frequency difference between the second memory subspace state 612B and the second gate subspace state 622B may be substantially equal). In an example embodiment, the first and second manipulation signals are characterized by different frequencies.

In an example embodiment where the first and second memory subspace states 612A, 612B are clock states, the memory subspace states are relatively insensitive to magnetic fields. However, the gate subspace states 622A, 622B are chosen or selected to be Zeeman states with quantum number m≠0 such that the gate subspace states are sensitive to magnetic fields.

The controller 30 controls operation of one or more manipulation sources 60 and/or beam/signal delivery systems 66 to cause one or more manipulation signals 630 (e.g., 630A, 630B) to be incident on at least a portion of the static magnetic field gradient zone 230 (and therefore incident on the two or more quantum objects). As a result of the one or more manipulation signals 630 being incident on the two or more quantum objects, the respective quantum states of the quantum objects are mapped and/or transformed from the respective memory subspace state 612 (or superposition of memory subspace states 612) to the respective gate subspace state 622 (or superposition of gate subspace states 622).

Various adiabatic couplings of the at least one memory subspace state to the respective gate subspace state may be used in various embodiments. In an example embodiment, the first adiabatic coupling is an adiabatic Rabi flip transition. In another example embodiment, the first adiabatic coupling is a RAP.

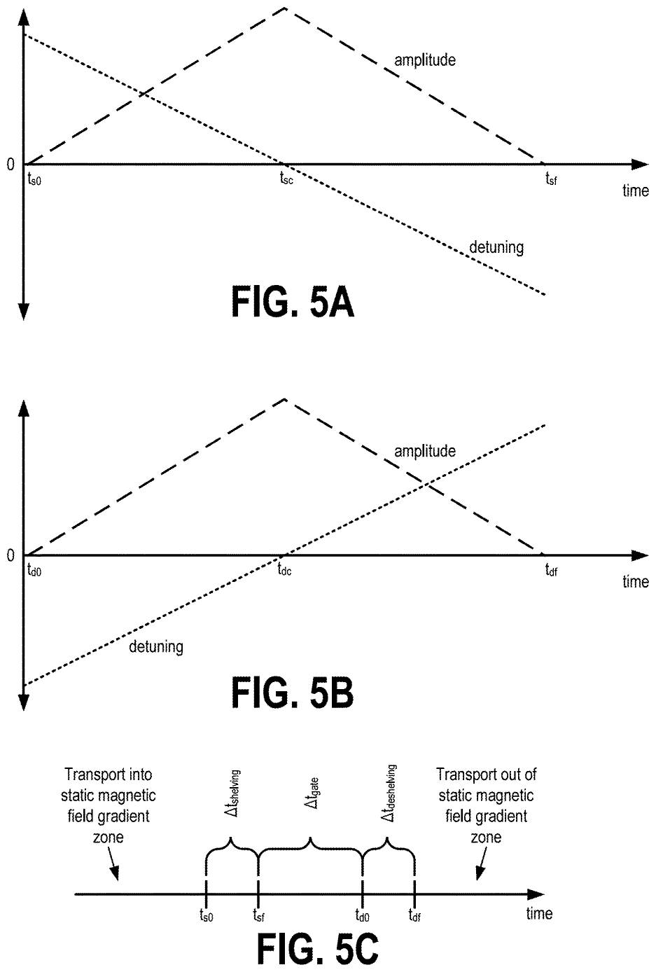

FIG. 5A provides a plot illustrating, in arbitrary units, the amplitude of the manipulation signal and detuning of the frequency of the manipulation signal from a frequency corresponding to the energy difference between the at least one memory subspace state and the respective gate subspace state over time (during the first adiabatic coupling). FIG. 5A illustrates an example embodiment where the first adiabatic coupling is performed as an RAP. For example, as shown in the timeline provided by FIG. 5C, the first adiabatic coupling begins at an initial shelving time tₛ₀ and ends at a final shelving time t_{sf}, where the time between the final shelving time t_{sf} and the initial shelving time tₛ₀ (e.g., t_{sf}-tₛ₀; a time duration of the first adiabatic coupling) is a shelving time Δt_{shelving}. In various embodiments, the shelving time Δt_{shelving} is in a range of 0.2 to 20 μs. In another example embodiment, the shelving time Δt_{shelving} is in a range of 1 to 10 μs (e.g., 5 to 10 μs).

A shown in FIG. 5A, the controller 30 controls operation of the manipulation source(s) 60 such that at the initial shelving time tso the manipulation signal is characterized by (i) a detuning from a transition between the at least one (magnetic field insensitive) memory state and the respective (magnetic field sensitive) gate subspace state that is equal to an initial detuning and (ii) an initial amplitude. In various embodiments, the initial detuning is not equal to zero and the initial amplitude is approximately equal to zero or just larger than zero. The controller 30 further controls operation of the manipulation source(s) 60 such that at the final shelving time t_{sf} the manipulation signal is characterized by (i) the detuning from the transition that is equal to a final detuning that is not equal to zero and that is of opposite size of the initial detuning and (ii) a final amplitude that is substantially equal to the initial amplitude. In an example embodiment, the absolute value of the initial detuning and the absolute value of the final detuning are substantially equal. For example, the final detuning is of substantially equal magnitude and opposite sign of the initial detuning, in an example embodiment. FIG. 6 illustrates an initial detuning δ₀ and a final detuning δ_{f} from the transition frequency v₁ corresponding to the energy difference between the first memory subspace state 612A and the first gate subspace state 622A.

In the embodiment illustrated in FIG. 5A, between the initial shelving time tₛ₀ and the final shelving time t_{sf}, the detuning monotonically transitions from the initial detuning to the final detuning. In the illustrated embodiment, the detuning transitions from the initial detuning to the final detuning linearly with respect to time during the shelving time. However, in various embodiments, the detuning transitions from the initial detuning to the final detuning logarithmically, exponentially, quadratically, in accordance with a step function, sinusoidally, and/or in another monotonic manner with respect to time during the shelving time. The detuning is equal to zero at a shelving crossing time t_{sc}, where tₛ₀<t_{sc}<t_{sf}. In an example embodiment, the shelving crossing time t_{sc} is halfway between the initial shelving time and the final shelving time (e.g., t_{sc}−tₛ₀=(t_{sf}−tₛ₀)/2). Between the initial shelving time tₛ₀ and the shelving crossing time t_{sc}, the amplitude monotonically increases from the initial amplitude to a maximum amplitude. Between the shelving crossing time t_{sc} and the final shelving time t_{sf}, the amplitude monotonically decreases from the maximum amplitude to the final amplitude. In an example embodiment, the final amplitude is substantially equal to the initial amplitude. In the illustrated embodiment, the amplitude changes (e.g., monotonically increases until the shelving crossing time t_{sc} and then monotonically decreases until the final shelving time t_{sf}) linearly with respect to time during the shelving time. However, in various other embodiments, the amplitude may change detuning logarithmically, exponentially, quadratically, in accordance with a step function, sinusoidally, and/or in another monotonic manner with respect to time during the shelving time. Various other adiabatic couplings may be used to perform the first adiabatic coupling in various embodiments.

In an example embodiment, the static magnetic field gradient is present in the static magnetic field gradient zone 230 prior to the two or more quantum objects being transported into the static magnetic field gradient zone 230 and/or prior to the performance of the first adiabatic coupling. In various embodiments, the static magnetic field gradient source 70 comprises one or more electromagnets and the static magnetic field gradient zone is turned on and/or caused to be present (e.g., the current flow to the electromagnet(s) is increased to a steady state current flow having an absolute value of greater than zero) as the two or more quantum objects are being transported into the static magnetic field gradient zone 230 and/or once the two or more quantum objects are disposed within the static magnetic field gradient zone 230 (but before the performance of the first adiabatic coupling). The performance of the first adiabatic coupling causes the two or more quantum objects to experience the magnetic field gradient present in the static magnetic field gradient zone as a result of the population transfer from the at least one (magnetic field insensitive) memory subspace state to the respective (magnetic field sensitive) gate subspace state.

Returning to FIG. 4, at step 408, the controller 30 causes one or more dynamic decoupling sequences to be performed on at least one of the two or more quantum objects upon which the quantum logic gate is being performed, in an example embodiment. In various embodiments, the one or more dynamic decoupling sequences are performed to prevent and/or mitigate the effects of spin-decoherence of at least one of the two or more quantum objects. In various embodiments, a dynamic decoupling sequence comprises applying a pi pulse to at least one of the two or more qubits, causing the spin of the qubit to flip. In an example embodiment, the one or more dynamic decoupling sequences comprise one or more Walsh sequences. Various other dynamic decoupling sequences are used in various other embodiments.

In various embodiments, one or more dynamic decoupling sequences are performed respectively on one or more of the two or more quantum objects during the gate time period. For example, for a gate time period Δt_{gate}, one or more dynamic decoupling sequences may be performed on respective quantum objects at times at any time during the gate time period Δt_{gate} (e.g., between the completion of the first adiabatic coupling (after t_{sf}) and the beginning of a second adiabatic coupling (before t_{d0})), in an example embodiment. In various embodiments, the timing of the performance of the dynamic decoupling sequence(s) is determined based in part on the dynamic decoupling sequence(s) utilized.

In various embodiments, the controller 30 is configured to perform a dynamic decoupling sequence on a quantum object by controlling operation of one or more manipulation sources 60 and/or beam/signal delivery systems 66 to cause on or more dynamic decoupling manipulation signals to be incident on a respective quantum object of the two or more quantum objects. In an example embodiment, a dynamic decoupling manipulation signal is a pi-pulse configured to correct and/or prevent errors caused by the energy splitting of the qubit drifting in an uncontrolled manner during performance of the quantum logic gate.

In various embodiments, the one or more dynamic decoupling manipulation signals are incident on the respective quantum objects while the quantum objects are disposed within the static magnetic field gradient zone 230. For example, in an example embodiment, when it is time to perform a dynamic decoupling sequence, the static magnetic field gradient is turned off (e.g., when the static magnetic field gradient source 70 comprises one or more electromagnets, the current flow to the electromagnets is reduced to nominally zero), the dynamic decoupling manipulation signals are applied to the respective quantum objects, and then the static magnetic field gradient is turned back on (e.g., the current flow to the electromagnets is increased to a steady state current flow having an absolute value of greater than zero). In an example embodiment, when it is time for a dynamic decoupling sequence to be performed on a quantum object, the quantum object is transported out of the static magnetic field gradient zone 230 (e.g., possibly into an oscillating field zone 220), the dynamic decoupling manipulation signal is incident on the quantum object, and then the quantum object is transported back into the static magnetic field gradient zone 230.

In various embodiments, the clock used to determine that the gate time period has elapsed since the two or more quantum objects started to experience the static magnetic field gradient and/or since the performance of the first adiabatic coupling was completed, is paused during the performance of the one or more dynamic decoupling sequences. In an example embodiment, the gate time period is determined and/or defined to include time for the one or more dynamic decoupling sequences to be performed during the gate time period Δt_{gate} and the clock is not paused for performance of the one or more dynamic decoupling sequences.

Continuing with FIG. 4, at step 410, the controller 30 determines that the gate time period Δt_{gate} has elapsed. For example, the controller 30 determines that the gate time period Δt_{gate} has elapsed since completion of the first adiabatic coupling. For example, the controller 30 determines that the two or more quantum objects have been experiencing the magnetic field gradient for the gate time period Δt_{gate}. For example, the controller 30 includes or is in communication with a clock that enables the controller 30 to count or track time, such as the elapsing of the shelving time t_{shelving} during which the first adiabatic coupling is performed, the gate time period Δt_{gate} during which the quantum logic gate and/or entangling of the two or more quantum objects occurs, and/or the deshelving time tdeshelving during which a second adiabatic coupling is performed.

In various embodiments, the gate time period is determined based at least in part on an amount of time that it takes for the static magnetic field gradient to enact, mediate, and/or cause the entanglement of two or more quantum objects. In an example embodiment, the static magnetic field gradient has a magnetic field strength and/or amplitude of greater than 100 T/m and the gate time period is less than 10⁴ μs. In an example embodiment, the static magnetic field gradient has a magnetic field strength and/or amplitude of greater than 200 T/m and the gate time period is less than 3×10³ μs. In an example embodiment, the static magnetic field gradient has a magnetic field strength and/or amplitude of greater than 300 T/m and the gate time period is less than 10³ μs. For example, in various embodiments, the gate time period is determined at least in part based on a function of the magnetic field strength and/or amplitude of the static magnetic field gradient, a motional frequency of one or more motional modes of the quantum objects, and/or the like.

Responsive to determining that the gate time period Δt_{gate} has elapsed, the process continues to step 412. At step 412, the controller 30 causes the at least one of the memory subspace states to be adiabatically coupled to the respective gate subspace state. For example, for each memory subspace state that was adiabatically coupled to a respective gate subspace state during the first adiabatic coupling, the memory subspace state is again adiabatically coupled to the respective gate subspace state during a second adiabatic coupling. For example, the first adiabatic coupling causes quantum objects (disposed within the static magnetic field gradient zone) in the at least one memory subspace state to be transferred to the respective gate subspace state such that the quantum objects experience the magnetic field gradient. The second adiabatic coupling causes the quantum objects (disposed within the static magnetic field gradient zone) in the respective gate subspace state(s) to be transferred to the respective at least one memory subspace state such that the quantum objects substantially stop experiencing the magnetic field gradient.

For example, the controller 30 may control operation of one or more manipulation sources to cause one or more manipulation signals (microwave signals, laser beams, and/or the like) to be incident on the two or more quantum objects disposed within the static magnetic field gradient zone 230 to cause a second adiabatic coupling. The one or more manipulation signals and/or the second adiabatic coupling cause(s) the respective gate subspace state(s) to be adiabatically coupled to the respective at least one memory subspace state. In various embodiments, adiabatically coupling the respective gate subspace state(s) to the respective at least one memory subspace state causes quantum objects in the respective gate subspace state(s) to transition to the respective at least one memory subspace state in an adiabatic manner.

As described above, an adiabatic coupling or a transition that is adiabatic in manner is a quantum state coupling or transition that occurs without transference of heat between the system (e.g., the quantum object) and its environment. In other words, the motional state of the quantum object is not affected or modified by the adiabatic coupling or a transition that is adiabatic in manner. For example, the internal quantum state of the quantum object may be modified without modifying the motional state of the quantum object as a result of the adiabatic coupling of the at least one memory subspace state to the respective gate subspace state.

For example, the controller 30 controls operation of one or more manipulation sources 60 and/or beam/signal delivery systems 66 to cause one or more manipulation signals 630 (e.g., 630A, 630B) to be incident on at least a portion of the static magnetic field gradient zone 230 (and therefore incident on the two or more quantum objects). As a result of the one or more manipulation signals 630 being incident on the two or more quantum objects, the respective quantum states of the quantum objects are mapped and/or transformed from the respective gate subspace state 622 (or superposition of gate subspace states 622) to the respective memory subspace state 612 (or superposition of memory subspace states 612).

Various adiabatic couplings of the at least one memory subspace state to the respective gate subspace state may be used in various embodiments. In an example embodiment, the first adiabatic coupling is an adiabatic Rabi flip transition. In another example embodiment, the first adiabatic coupling is a RAP.

FIG. 5B provides a plot illustrating, in arbitrary units, the amplitude of the manipulation signal and detuning of the frequency of the manipulation signal from a frequency corresponding to the energy difference between the at least one memory subspace state and the respective gate subspace state over time (during the second adiabatic coupling). FIG. 5B illustrates an example embodiment where the second adiabatic coupling is performed as an RAP. For example, as shown in the timeline provided by FIG. 5C, the second adiabatic coupling begins at an initial deshelving time tdo and ends at a final deshelving time t_{df}, where the time between the final deshelving time t_{df} and the initial deshelving time t_{d0} (e.g., t_{df}−t_{d0}; a time duration of the second adiabatic coupling) is a deshelving time Δt_{deshelving}. In various embodiments, the deshelving time Atdeshelving is in a range of 0.2 to 20 μs. In another example embodiment, the deshelving time Δt_{deshelving} is in a range of 1 to 10 μs (e.g., 5 to 10 μs).

A shown in FIG. 5B, the controller 30 controls operation of the manipulation source(s) 60 such that at the initial deshelving time t_{d0} the manipulation signal is characterized by (i) a detuning from a transition between the at least one (magnetic field insensitive) memory state and the respective (magnetic field sensitive) gate subspace state that is equal to an initial detuning and (ii) an initial amplitude. In various embodiments, the initial detuning is not equal to zero and the initial amplitude is approximately equal to zero or just larger than zero. In an example embodiment, initial detuning of the second adiabatic coupling is substantially equal to the final detuning of the first adiabatic coupling. The controller 30 further controls operation of the manipulation source(s) 60 such that at the final deshelving time t_{df} the manipulation signal is characterized by (i) the detuning from the transition being equal to a final detuning that is not equal to zero and that is of opposite size of the initial detuning and (ii) a final amplitude that is substantially equal to the initial amplitude. In an example embodiment, the absolute value of the initial detuning and the absolute value of the final detuning are substantially equal. For example, the final detuning is of substantially equal magnitude and opposite sign of the initial detuning, in an example embodiment.

In the embodiment illustrated in FIG. 5B, between the initial deshelving time t_{d0} and the final deshelving time t_{df}, the detuning monotonically transitions from the initial detuning to the final detuning. In the illustrated embodiment, the detuning transitions from the initial detuning to the final detuning linearly with respect to time during the deshelving time. However, in various embodiments, the detuning transitions from the initial detuning to the final detuning logarithmically, exponentially, quadratically, in accordance with a step function, sinusoidally, and/or in another monotonic manner with respect to time during the deshelving time. The detuning is equal to zero at a deshelving crossing time t_{dc}, where t_{d0}<t_{dc}<t_{df}. In an example embodiment, the deshelving crossing time t_{dc} is halfway between the initial deshelving time and the final deshelving time (e.g., t_{dc}−t_{d0}=(t_{df}−t_{d0})/2). Between the initial deshelving time t_{d0} and the deshelving crossing time t_{dc}, the amplitude monotonically increases from the initial amplitude to a maximum amplitude. Between the deshelving crossing time t_{dc} and the final deshelving time t_{df}, the amplitude monotonically decreases from the maximum amplitude to the final amplitude. In various embodiments, the initial amplitude and/or the final amplitude are a minimum amplitude. In an example embodiment, the final amplitude is substantially equal to the initial amplitude. In the illustrated embodiment, the amplitude changes (e.g., monotonically increases until the deshelving crossing time t_{dc} and then monotonically decreases until the final deshelving time t_{sf}) linearly with respect to time during the deshelving time. However, in various other embodiments, the amplitude may change detuning logarithmically, exponentially, quadratically, in accordance with a step function, sinusoidally, and/or in another monotonic manner with respect to time during the deshelving time. For example, the second adiabatic coupling is the first adiabatic coupling performed in reverse, in an example embodiment. Various other adiabatic couplings may be used to perform the first adiabatic coupling in various embodiments.

The performance of the second adiabatic coupling causes the two or more quantum objects to substantially stop experience the magnetic field gradient present in the static magnetic field gradient zone as a result of the population transfer from the respective (magnetic field sensitive) gate subspace state(s) to the respective at least one (magnetic field insensitive) memory subspace state.

Continuing with FIG. 4, at step 414 the controller 30 causes the two or more quantum objects upon which the quantum logic gate has been performed to be transported out of the static magnetic field gradient zone 230. For example, the controller 30 may control operation of the voltage sources 80, filters 85, and/or confinement apparatus 50 such that the potential well(s) in which the two or more quantum objects are disposed to be transported out of a static magnetic field gradient zone 230. In various embodiments, the two or more quantum objects are in respective magnetic field insensitive states (e.g., “clock” states or m=0 states) of the memory subspace while the two or more quantum objects are transported out of the static magnetic field gradient zone 230. In an example embodiment, the potential generating signals that are applied to the control electrodes of the confinement apparatus 50 that are configured to cause the transportation of the two or more quantum objects out of the static magnetic field gradient zone 230 are filtered by filters 85 in accordance with the first potential generating signal filtering scheme.

After the performance of the quantum logic gate is completed, the controller 30 may continue to control operation of various components of the quantum processor 115 to cause the quantum processor 115 to continue and/or finish performing the quantum circuit and/or algorithm including the quantum logic gate. For example, respective quantum objects of the two or more quantum objects may be transported, have one or more single qubit gates performed thereon, have one or more two or more qubit gates performed thereon, have one or more read operations performed thereon, and/or the like, in accordance with the quantum circuit and/or algorithm.

As should be understood, the manipulation signal(s) used to couple and/or map the respective quantum states of the two or more quantum objects from memory subspace states to gate subspace states or vice versa and any dynamic decoupling manipulation signals used to perform the one or more dynamic decoupling sequences are each acting independently on a single quantum object. In other words, the manipulation signal(s) used to couple and/or map the respective quantum states of the two or more quantum objects from memory subspace states to gate subspace states or vice versa and any dynamic decoupling manipulation signals do not enact, mediate, and/or cause interaction and/or entanglement between the two or more quantum objects. The interaction and/or entanglement between the two or more quantum objects is enacted, mediated, and/or caused solely by the static magnetic field gradient.

### Technical Advantages

Performance of conventional quantum logic gates require oscillating fields such as laser beams, microwaves, oscillating magnetic fields, and/or the like to enact, mediate, and/or cause the entanglement of qubits. However, these oscillating fields may lead to various gate errors such as photon scattering and/or affecting transitions in spectator qubits, which can lead to crosstalk problems, phase noise, and/or the like. These gate errors can lead to low fidelity logic gates and noisy computations. Moreover, quantum logic gates that use oscillating fields are highly sensitive to state of one or more the motional modes of the qubits. Therefore, spin-motion coupling can lead to additional gate errors and/or a significant amount of time is needed to cool the qubits to close to their motional ground states prior to performance of a quantum logic gate. Thus, various technical problems exist regarding the performance of quantum logic gates.

Various embodiments provide technical solutions to these technical problems. In various embodiments, a quantum logic gate is performed by using a static magnetic field gradient to enact, mediate, and/or cause entanglement of two or more qubits. Since the static magnetic field gradient is a static field (e.g., substantially not changing with time at least during the performance of the quantum logic gate), the quantum logic gate disclosed herein is immune to phase noise and the primary mechanisms leading to cross talk-related errors. As an optical beam is not used to enact, mediate, or cause the entanglement of the two or more quantum objects, photon scattering error sources are reduced. Additionally, the quantum logic gate of various embodiments is insensitive to the motional mode and/or temperature of the qubits. Thus, time intensive cooling operations can be avoided and/or reduced. As such, various embodiments provide an improved quantum logic gate, methods for performing an improved quantum logic gate, quantum systems configured for performing an improved quantum logic gate, controller configured to cause quantum systems to perform an improved quantum logic gate, and/or the like.

Moreover, in order to perform a static magnetic field gradient-mediated and/or enacted quantum logic gate that is insensitive to motional errors, the qubits on which the quantum logic gate is being enacted should experience the static magnetic field gradient turning on and/or ramping up slowly compared to the motional frequency of the qubits, which is dictated by the trap confinement. This slow turn on and/or ramp up of the qubit experiencing the static magnetic field gradient is performed, in various embodiments, by transporting the qubits to be gated together into a static magnetic field gradient zone defined by the confinement apparatus where the static magnetic field gradient is present. The qubits are transported while in respective “clock” states (e.g., magnetic field insensitive states with quantum number m=0) of the memory subspace of the quantum objects embodying the qubits.

### Example Controller

In various embodiments, a confinement apparatus 50 and an associated at least one static magnetic field gradient source 70 that define at least one static magnetic field gradient zone 230 are part of a QCCD-based quantum system 100 or other quantum system. In various embodiments, the QCCD-based quantum system 100 or other quantum system comprises a controller 30 configured, for example, to control operation of various components of a quantum processor 115. For example, the controller 30 is configured to control the voltage sources 80 configured to provide potential generating signals to the sequences of control electrodes 212 of the confinement apparatus 50. For example, the controller 30 is configured to control operation of filters 85 configured to filter the potential generating signals provided to the sequences of control electrodes 212 of the confinement apparatus 50. The controller 30 may be further configured to control a cryogenic system and/or vacuum system controlling the temperature and pressure within the cryogenic and/or vacuum chamber 40, manipulation sources 60, beam/signal delivery systems 66, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the atomic object confinement apparatus 50.

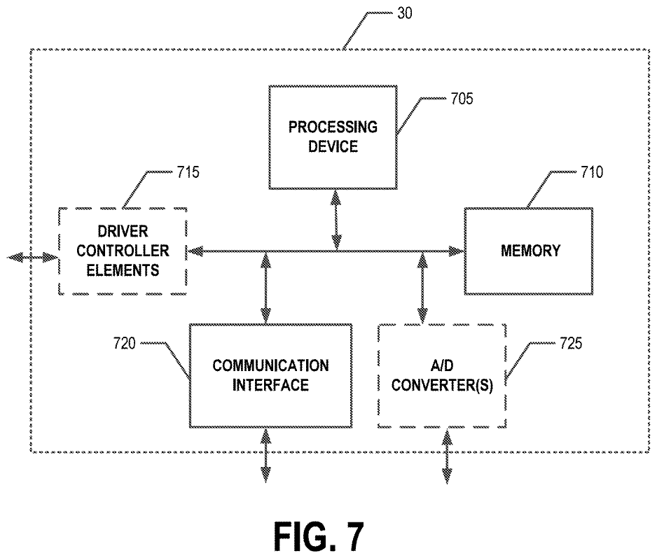

As shown in FIG. 7, in various embodiments, the controller 30 may comprise various controller elements including processing device(s) 705, memory 710, driver controller elements 715, a communication interface 720, analog-digital converter elements 725, and/or the like. For example, the processing device(s) 705 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device(s) 705 of the controller 30 comprises a clock and/or is in communication with a clock.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing device 705) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 705). In various embodiments, the driver controller elements 715 may enable the controller 30 to operate a manipulation source 60 to provide one or more manipulation signals, voltage sources 80 to provide respective potential generating signals to respective control electrodes 214, filters 85 to filter potential generating signals (e.g., in accordance with first and/or second potential generating signal filtering schemes), any electromagnets of the static magnetic field gradient source 70, and/or the like. In various embodiments, the driver controller elements 715 enable the controller 30 to control and/or operate various drivers (e.g., laser drivers; vacuum component drivers; cryogenic and/or vacuum system component drivers; and/or the like).

In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 725 configured to receive signals from one or more optical receiver components, calibration sensors, and/or the like.

In various embodiments, the controller 30 may comprise a communication interface 720 for interfacing and/or communicating with a computing entity 10. For example, the controller 30 may comprise a communication interface 720 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

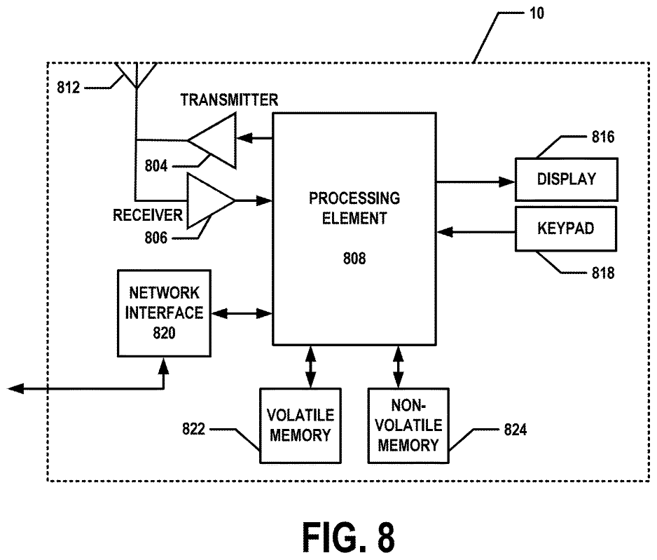

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 8, a computing entity 10 can include an antenna 812, a transmitter 804 (e.g., radio), a receiver 806 (e.g., radio), and a processing element 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. In various embodiments, the computing entity 10 comprises a network interface 820 configured to enable communication between the computing entity 10 and the controller 30 and/or various other computing apparatuses. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 816 and/or speaker/speaker driver coupled to a processing element 808 and a touch screen, keyboard, mouse, and/or microphone coupled to a processing element 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for performing a geometric phase gate, the method performed by a controller configured to control operation of one or more components of a quantum system comprising a confinement apparatus (a) configured to confine at least two quantum objects and (b) defining at least one static magnetic field gradient zone, the method comprising:
causing a first adiabatic coupling of at least one memory state of two or more quantum objects of the at least two quantum objects to a respective magnetic field sensitive state of two or more quantum objects while the two or more quantum objects are disposed within the at least one static magnetic field gradient zone, wherein the first adiabatic coupling is performed for a shelving time; and
responsive to determining that a gate time period has elapsed since a completion of the shelving time, causing a second adiabatic coupling of the at least one memory state to the respective magnetic field sensitive state while the two or more quantum objects are disposed within the at least one static magnetic field gradient zone.

2. The method of claim 1, wherein the two or more quantum objects are entangled within the static magnetic field gradient zone during the gate time period without use of any oscillating fields to enact entanglement of the two or more quantum objects.

3. The method of claim 1, wherein the static magnetic field gradient enacts entanglement of the two or more quantum objects within the static magnetic field gradient zone.

4. The method of claim 3, wherein the gate time period is determined based at least in part on an amount of time it takes for the static magnetic field gradient to mediate/enact/cause the entanglement of the two or more quantum objects.

5. The method of claim 1, wherein causing the first adiabatic coupling comprises causing a manipulation signal that (a) at an initial time is characterized by (i) a detuning from a transition between the at least one memory state and the respective magnetic field sensitive state that is equal to an initial detuning and (ii) an initial amplitude, (b) at a finale time is characterized by (i) the detuning from the transition that is equal to a final detuning that is of substantially equal magnitude and opposite sign of the initial detuning and (ii) a final amplitude substantially equal to the initial amplitude, and (c) between the initial time and the final time, (i) the detuning smoothly and monotonically transitions from the initial detuning to the final detuning and (ii) the amplitude increases from the initial amplitude to a maximum amplitude and then decreases from the maximum amplitude to the final amplitude, the amplitude being equal to the maximum amplitude when the detuning from the transition is equal to zero.

6. The method of claim 1, wherein the first adiabatic coupling is a rapid adiabatic passage, and the second adiabatic coupling is a reverse of the first adiabatic coupling.

7. The method of claim 6, wherein the second adiabatic coupling is performed for a deshelving time.

8. The method of claim 7, wherein the shelving time and the deshelving time are respectively in a range of 5-10 μs.

9. The method of claim 7, wherein at least one of the first adiabatic coupling or the second adiabatic coupling is a Rabi flop transition.

10. The method of claim 1, further comprising, prior to causing the first adiabatic coupling, causing the two or more quantum objects to be transported into the at least one static magnetic field gradient zone.

11. The method of claim 10, wherein a first potential generating signal filtering scheme is used to filter potential generating signals used to cause the two or more quantum objects to be transported into the at least one static magnetic field gradient zone.

12. The method of claim 11, wherein a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

13. The method of claim 1, further comprising, after causing the second adiabatic coupling to be performed for a deshelving time, causing the two or more quantum objects to be transported out of the at least one static magnetic field gradient zone.

14. The method of claim 13, wherein a first potential generating signal filtering scheme is used to filter potential generating signals used to cause the two or more quantum objects to be transported out of the at least one static magnetic field gradient zone.

15. The method of claim 14, wherein a second potential generating signal filtering scheme that is different from the first potential generating signal filtering scheme is used to filter potential generating signals used to confine the two or more quantum objects within the static magnetic field gradient zone during performance of the first adiabatic coupling, the gate time period, and performance of the second adiabatic coupling.

16. The method of claim 1, wherein causing at least one of the first adiabatic coupling or the second adiabatic coupling comprises controlling operation of a manipulation source of the quantum system to cause at least one manipulation signal to be incident on the two or more quantum objects disposed within the static magnetic field gradient zone.

17. The method of claim 16, wherein the at least one manipulation signal comprises at least one of a microwave signal or a laser beam.

18. A system configured for performing a geometric phase gate, the system comprising:
a confinement apparatus (a) configured to confine at least two quantum objects and (b) defining at least one magnetic field gradient zone; and
a controller configured to control operation of the confinement apparatus, the controller configured to perform at least:
causing a first adiabatic coupling of at least one memory state of two or more quantum objects of the at least two quantum objects to a respective magnetic field sensitive state of two or more quantum objects while the two or more quantum objects are disposed within the at least one magnetic field gradient zone, wherein the first adiabatic coupling is performed for a shelving time; and
responsive to determining that a gate time period has elapsed since a completion of the shelving time, causing a second adiabatic coupling of the at least one memory state to the respective magnetic field sensitive state while the two or more quantum objects are disposed within the at least one magnetic field gradient zone.

19. The system of claim 18, wherein the first adiabatic coupling is a rapid adiabatic passage, and the second adiabatic coupling is a reverse of the first adiabatic coupling.

20. A controller configured to control one or more components of a quantum system to cause the quantum system to perform a geometric phase gate, the quantum system comprising a confinement apparatus (a) configured to confine at least two quantum objects and (b) defining at least one magnetic field gradient zone, the controller configured to at least:
causing a first adiabatic coupling of at least one memory state of two or more quantum objects of the at least two quantum objects to a respective magnetic field sensitive state of two or more quantum objects while the two or more quantum objects are disposed within the at least one magnetic field gradient zone, wherein the first adiabatic coupling is performed for a shelving time; and
responsive to determining that a gate time period has elapsed since a completion of the shelving time, causing a second adiabatic coupling of the at least one memory state to the respective magnetic field sensitive state while the two or more quantum objects are disposed within the at least one magnetic field gradient zone.
